(19) United States
(12) Patent Application Publication
(10) Pub. No.: US 2009/0197081 A1
(43) Pub. Date: Aug. 6, 2009

(54) Beta-KETOCARBONYL-FUNCTIONAL SILOXANE POLYMER-CONTAINING COMPOSITIONS

(75) Inventors: Christian Herzig, Waging (DE); Siegfried Dormeier, Stubenberg (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/438,440

(22) PCT Filed: Aug. 6, 2007
(86) PCT No.: PCT/EP2007/058143

§ 371 Date: Feb. 23, 2009

(30) Foreign Application Priority Data
Aug. 25, 2006 (DE) 10 2006 039 940.4

(51) Int. Cl. C08G 16/00; D02G 3/00

(52) U.S. Cl. 428/365; 525/471; 428/391

(57) ABSTRACT

β-ketocarbonyl-functional organosilicon compounds in combination with an Si-free polyamine having at least two primary amino groups, provide storage stable compositions useful for fabric treating. The treated fabrics show less propensity toward yellowing.

This invention relates to compositions comprising β-ketocarbonyl-functional siloxane polymers and processes for their preparation.

U.S. Pat. No. 6,121,404 A states that a polyether siloxane copolymer having a short-chain siloxane block which comprises β-ketocarbonyl functions and is water soluble is crosslinkable with aminosiloxanes into an elastomeric film. The β-ketocarbonyl-functional siloxane polymer is first dissolved in water, then the aminosiloxane is added to it, and the aqueous solution is dried to leave an elastomeric film.

The β-ketocarbonyl-functional siloxanes are said in U.S. Pat. No. 6,121,404 to be useful for textile treatment. However, it is important in the treatment of textiles that the textiles thus finished yellow as little as possible, if at all.

EP 603 716 A1 describes polyether and polyester acetoacetates having 2 or more functions, which can be crosslinked with polyamines. The polyamines are generally used in excess.

A liquid coating composition can be prepared as described in EP 481 345 A2 by mixing a polymeric acetoacetate prepared from a polyepoxide with water, amine or hydroxy carboxylic acid with subsequent esterification with acetoacetic acid, and a polyketimine or polyaldimine.

A similar technique is described in EP 199 087 A1. The polyacetoacetate here is obtained by addition polymerization of an unsaturated acetoacetic ester.

U.S. Pat. No. 3,668,183 A discloses preparing polyenamine resins by reaction of polyacetoacetates/-acetamides and blocked polyamines. These resins gel after a short pot life to form solid masses.

In J. prakt. Chem. 336, 483-491 (1994) polyether acetoacetates are reacted with diamines to obtain amino-functional polyether enamines, which are chain extended with diisocyanates.

EP 442 653 A2 describes a method of functionalizing polymers containing primary or secondary amino groups which comprises reacting these polymers with a compound containing exactly one enolic carbonyl group and at least one of the functions to be grafted.

The present invention has for its object to provide β-ketocarbonyl-functional siloxane polymer compositions, or reaction products obtained therefrom, which are suitable for textile treatment in that the textiles or textile fabrics thus treated shall exhibit very little yellowing, if any. The present invention also has for its object to provide compositions, or reaction products, whose mixtures with water are stabler than the mixtures with water of the β-ketocarbonyl-functional siloxane polymers used.

We have found that this object is achieved by the invention.

The present invention accordingly provides compositions containing
(1) β-ketocarbonyl-functional siloxane polymers containing at least one trivalent radical B of the general formula

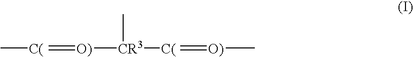

where
R³ represents a hydrogen atom or a monovalent hydrocarbyl radical having 1 to 30 carbon atoms, preferably a hydrogen atom,
(2) organic Si-free polyamines containing at least three amino groups of which at least two are primary amino groups,
and optionally
(3) silicon-free compounds containing at least one radical B of formula (I) or at least one primary amino group.

The present invention further provides a process for preparing the compositions by preparing a mixture containing
(1) β-ketocarbonyl-functional siloxane polymers containing at least one trivalent radical B of the general formula

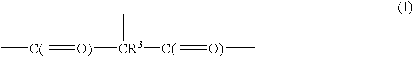

where
R³ represents a hydrogen atom or a monovalent hydrocarbyl radical having 1 to 30 carbon atoms, preferably a hydrogen atom,
(2) organic Si-free polyamines containing at least three amino groups of which at least two are primary amino groups,
and optionally
(3) Si-free compounds containing at least one radical B of formula (I) or at least one primary amino group.

The present invention further provides a reaction product obtainable by reacting the compositions of the present invention.

Radical B in formula (I) preferably has at most one of the three free valences attached to heteroatoms.

In the siloxane polymers (1) the number of B radicals per average molecule is preferably at least 2 and more preferably in the range from 2 to 20. The organic radicals B are preferably attached to the siloxane part of the siloxane polymers (1) via Si—C groups.

In the event that the trivalent radical B is attached to heteroatoms with none of the free valences, the siloxane polymers (1) of the present invention preferably contain at least one SiC-attached radical B¹ selected from the group of the general formulae

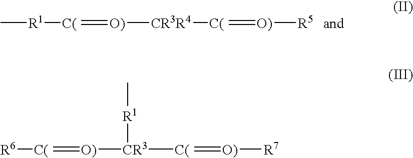

where R³ is as defined above,
R¹ represents a bivalent organic radical which has 1 to 200 carbon atoms and which, except in the terminal positions, may contain heteroatoms selected from the group of oxygen, sulfur and nitrogen, preferably represents a hydrocarbyl radical having 1 to 20 carbon atoms,
R⁴ is a hydrogen atom or a hydrocarbyl radical having 1 to 30 carbon atoms, preferably a hydrogen atom, and
R⁵, R⁶ and R⁷ each represent a hydrocarbyl radical having 1 to 30 carbon atoms.

The radicals B¹ of the formulae (II) and (III) have the structure of a substituted acetylacetone which is attached to a siloxane polymer via R¹.

In the event that the trivalent radical B is attached to heteroatoms with one of the free valences, the siloxane polymers (1) of the present invention preferably contain at least one SiC-attached radical B² selected from the group of the general formulae

—R⁸—Y—C(═O)—CHR³—C(═O)—CH₂R³ (IV) and

—R⁸—Y—C(═O)—CR³═C(—OH)—CH₂R³ (V)

where
Y represents an oxygen atom or a radical of the formula —(NR⁹—R′)_{z}—NR², preferably an oxygen atom,
where R′ represents a bivalent hydrocarbyl radical having 1 to 6 carbon atoms, preferably a bivalent hydrocarbyl radical having 1 to 4 carbon atoms,
R² represents a hydrogen atom or a hydrocarbyl radical having 1 to 18 carbon atoms, preferably a hydrogen atom,
R³ is as defined above,
R⁸ represents a bivalent organic radical which has 1 to 200 carbon atoms and which may contain heteroatoms selected from the group of oxygen, sulfur and nitrogen, preferably represents a bivalent hydrocarbyl radical which has 1 to 120 carbon atoms and may contain one or more mutually separate oxygen atoms,
R⁹ represents R² or a radical of the formula —C(═O)—CHR³—C(═O)—CH₂R³ or —C(═O)—CR³═C(—OH)—CH₂R³,
z is 0 or a whole number from 1 to 10, preferably 0, 1 or 2.

The radicals B² of the formulae (IV) and (V) are attached to the siloxane polymer via the radicals R⁸.

The radicals B² are preferred for use as radicals B.

The radicals B² of the formulae (IV) and (V) are tautomeric groups. The siloxane polymers of the present invention preferably contain at least 2 radicals B² from the group of the formulae (IV) and (V) per molecule in which case they can contain just radicals of the formula (IV), just radicals of the formula (V) or both together. Since tautomeric groups are inter-convertable, their respective content can change as a function of external conditions. Their ratio can therefore vary within wide limits and be in the range from about 1000:1 to about 1:1000.

The enol content of the siloxane polymers (1) of the present invention leads to a weakly acidic character for these materials, which is chiefly dependent on the structural parameters and substituents of the group of the general formula (I). The pKa value of this enolizable group is preferably greater than 5.0, more preferably in the range from 6.0 to 15.0, and specifically in the range from 7.0 to 14.0.

In the event that the trivalent radical B is attached to heteroatoms with two free valences, the siloxane polymers (1) of the present invention preferably contain at least one SiC-attached radical B³ selected from the group of the general formulae

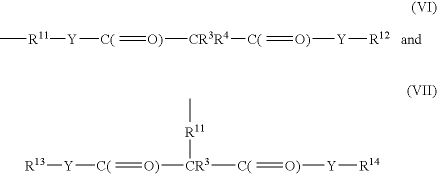

where R³ and R⁴ are each as defined above,
R¹¹ represents a bivalent organic radical, preferably a bivalent organic radical which has 1 to 200 carbon atoms and which may contain heteroatoms selected from the group of oxygen, sulfur and nitrogen, preferably represents a hydrocarbyl radical having 1 to 120 carbon atoms,
R¹², R¹³ and R¹⁴ have the meanings of R⁵, R⁶ and R⁷.

The siloxane polymers (1) of the present invention preferably contain 5 to 5000 silicon atoms and more preferably contain 50 to 1000 silicon atoms, per molecule. They can be linear, branched, dendrimeric or cyclic. The range of siloxane polymers (1) which are in accordance with the present invention also includes network structures of any size, to each of which neither a concrete number nor an average number of silicon atoms is assignable, provided they contain at least 2 functional groups B of the formula (I).

The β-ketocarbonyl-functional siloxane polymers (1) of the present invention are preferably organo-polysiloxanes composed of units of the general formula

$${X}_{a} {{R}_{c} ( {O R}^{15} )}_{d} {SiO}_{\frac{4 - ( a + c + d )}{2}} , \qquad ( VIII )$$

where
X represents an organic radical which contains the radical B, preferably is an SiC-attached radical B¹, B² or B³, where B, B¹, B² and B³ are each as defined above,
R represents a monovalent, optionally substituted hydrocarbyl radical having 1 to 18 carbon atoms per radical,
R¹⁵ represents a hydrogen atom or an alkyl radical having 1 to 8 carbon atoms, preferably a hydrogen atom or a methyl or ethyl radical,
a is 0 or 1,
c is 0, 1, 2 or 3, and
d is 0 or 1,
   with the proviso that the sum total a+c+d is ≦3 and on average at least one radical X is present per molecule.

Preferred examples of the β-ketocarbonyl-functional siloxane polymers (1) of the present invention are organopolysiloxanes of the general formula

X_{g}R_{3-g}SiO(SiR₂O)ₗ(SiRXO)ₖSiR_{3-g}X_{g} (IXa) and

(R¹⁵O)R₂SiO(SiR₂O)ₙ(SiRXO)ₘSiR₂(OR¹⁵) (IXb)

where X, R and R¹⁵ are each as defined above,
g is 0 or 1,
k is 0 or a whole number from 1 to 30,
l is 0 or a whole number from 1 to 1000,
m is a whole number from 1 to 30, and
n is 0 or a whole number from 1 to 1000,
with the proviso that on average at least one radical X is present per molecule.

Examples of radicals R are alkyl radicals, such as methyl, ethyl, n-propyl, isopropyl, 1-n-butyl, 2-n-butyl, isobutyl, tert-butyl, n-pentyl, isopentyl, neopentyl, tert-pentyl, hexyl radicals, such as n-hexyl, heptyl radicals, such as n-heptyl, octyl radicals, such as n-octyl and isooctyl, such as 2,2,4-trimethylpentyl, nonyl radicals, such as n-nonyl, decyl radicals, such as n-decyl, dodecyl radicals, such as n-dodecyl, and octadecyl radicals, such as n-octa-decyl; cycloalkyl radicals, such as cyclopentyl, cyclohexyl, cycloheptyl and methylcyclohexyl radicals; alkenyl radicals, such as vinyl, 5-hexenyl, cyclohexenyl, 1-propenyl, allyl, 3-butenyl and 4-pentenyl; alkynyl radicals, such as ethynyl, propargyl and 1-propynyl; aryl radicals, such as phenyl, naphthyl, anthryl and phenanthryl; alkaryl radicals, such as o-, m-, p-tolyl radicals, xylyl radicals and ethylphenyl radicals; and aralkyl radicals, such as benzyl, α-phenylethyl and β-phenyl-ethyl.

Examples of radicals R¹ are

—CH₂CH₂—, —CH(CH₃)—, —CH₂CH₂CH₂—, —CH₂C(CH₃)H—, —CH₂CH₂CH₂CH₂—, —CH₂CH₂CH(CH₃)— and —CH₂CH₂C(CH₃)₂CH₂—,
of which the —CH₂CH₂CH₂— radical is preferred.

The radical R′ is preferably a radical of the formula —CH₂CH₂— and —CH₂CH₂CH₂—.

Examples of radicals R³ are alkyl radicals, such as methyl, ethyl, n-propyl, isopropyl, 1-n-butyl, 2-n-butyl, isobutyl, tert-butyl, n-pentyl, isopentyl, neopentyl, tert-pentyl, hexyl radicals, such as n-hexyl, heptyl radicals, such as n-heptyl, octyl radicals, such as n-octyl and isooctyl, such as 2,2,4-trimethylpentyl, nonyl radicals, such as n-nonyl, decyl radicals, such as n-decyl, dodecyl radicals, such as n-dodecyl, and octadecyl radicals, such as n-octa-decyl; cycloalkyl radicals, such as cyclopentyl, cyclohexyl, cycloheptyl and methylcyclohexyl radicals; aryl radicals, such as phenyl, naphthyl, anthryl and phenanthryl; alkaryl radicals, such as o-, m-, p-tolyl radicals, xylyl radicals and ethylphenyl radicals; and aralkyl radicals, such as benzyl, α-phenylethyl and β-phenylethyl.

Examples of hydrocarbyl radicals R³ also hold for hydrocarbyl radicals R².

Examples of hydrocarbyl radicals R³ also hold for hydrocarbyl radicals R⁴, R⁵, R⁶, R⁷, R¹², R¹³ and R¹⁴.

Examples of radicals R¹¹ are the examples mentioned for radicals R¹ and also polyether radicals of polyethylene oxide, polypropylene oxide, poly-THF, and also their copolymers up to 200 carbon atoms.

Examples of hydrocarbyl radicals R¹⁵ are alkyl radicals, such as methyl, ethyl, n-propyl, isopropyl, 1-n-butyl, 2-n-butyl, isobutyl, tert-butyl, n-pentyl, isopentyl, neopentyl, tert-pentyl, hexyl radicals, such as n-hexyl, heptyl radicals, such as n-heptyl, octyl radicals, such as n-octyl and isooctyl radicals, such as 2,2,4-trimethylpentyl.

The radicals B¹ of the formulae (II) and (III) are β-diketone groups which are attached to a siloxane polymer via R¹ either terminally, based on the diketone (formula (II)), or at the carbon atom between the two carbonyl groups (formula (III)).

Processes for preparing β-ketocarbonyl-functional siloxane polymers (1) having radicals B¹ of formula (II) are known from organic chemistry. They are preferably obtained via acylation of acetoacetates with organosilicon compounds containing Si-attached acyl chlorides. When, for example, siloxane polymers which contain Si-attached undecanoyl chloride (R¹=—C₁₀H₂₀—) are reacted with ethyl acetoacetate (CH₃—C(═O)—CH₂—C(═O)—O—CH₂CH₃) (acylation) and subsequently CO₂ and ethanol are detached by thermal elimination, siloxane polymers are obtained with radicals B¹ of formula (II) where R¹=—C₁₀H₂₀—, R³=H, R⁴=H and R⁵=—CH₃.

Processes for preparing β-ketocarbonyl-functional siloxane polymers (1) which contain radicals B¹ of formula (III) are described in DE 1193504 A and DE 1795563 A. Preference here is given to the hydrosilylation of allylacetylacetone to form siloxane polymers which contain radicals B¹ of formula (III) where R¹=—C₃H₆—, R³=H, R⁶=R⁷=—CH₃. A further preferred process is the alkylation of acetylacetone by siloxane polymers having Si-attached halogen groups, such as —CH₂Cl, —CH₂Br, —C₃H₆Cl or —C₃H₆I.

Processes for preparing siloxane polymers (1) which contain radicals B² of formulae (IV) and (V) are described in U.S. Pat. No. 6,121,404 A.

When Y in the formulae (IV) and (V) is an oxygen atom, which is preferable, the radicals R⁸ can contain one or more mutually separate oxygen atoms. Examples of radicals R⁸ which contain oxygen atoms are polyether radicals, such as

—R¹⁰—(OC₂H₄)ₑ—(OC₃H₆)_{f}—(C₄H₈)ₕ—OCᵢH₂ᵢ—(Y) (X)

where R¹⁰ represents an alkylene radical having 2 to 20 carbon atoms, such as —CH₂CH₂CH₂—, —CH₂CH₂—, —CH₂CH₂CH₂CH₂—, —CH₂CH₂C(CH₃)₂— or —CH₂CH₂CH₂CH₂CH₂CH₂—,
—(Y) is the bond to Y in the formulae (IV) and (V), where Y is an oxygen atom,
e, f, and h each represent 0 or a whole number from 1 to 100 with the proviso that the sum total e+f+h is ≧1, and i is 2, 3 or 4.
Such siloxane polymers (1) are preferably prepared from silicone polyethers obtained in a hydrosilylation reaction of α,ω-dihydroorganopolysiloxanes with allyl polyethers. These silicone polyethers are reacted with diketenes or diketene adducts.

When Y in the formulae (IV) and (V) is a nitrogen-containing radical of the formula —(NR⁹—R′)_{z}—NR²—, the siloxane polymers (1) are preferably prepared by reacting diketenes (i) of the general formula

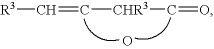

where R³ is as defined above and preferably is a hydrogen atom,
with organosilicon compounds (ii) which contain at least one Si-attached radical A of the general formula

—R⁸—(NR⁹—R′)_{z}—NR²₂ (XI)

per molecule, where R⁸, R′, R², R⁹ and z are each as defined above,
with the proviso that the radical A of formula (XI) includes at least one primary and, where appropriate, at least one secondary amino group, preferably at least one primary amino group.

The reaction preferably takes place in the presence of organic compounds (iii) which retard or inhibit the reaction of primary or secondary amino groups with β-ketocarbonyl compounds.

As organic compounds (iii) it is preferable to use organic compounds which combine with amines to form more or less solid adducts. Examples of compounds (iii) are aldehydes and ketones. Preferred examples are acetone, butanone, methyl isobutyl ketone and cyclohexanone.

A preferred method of preparation comprises a 1st stage of reacting organosilicon compounds (II) with organic compounds (iii) to cause the compounds (iii) to form protective groups on the amino groups in the radical A of formula (XI), and subsequently a 2nd stage of reacting the organosilicon compounds (ii) obtained in the 1st stage and having protected amino groups (reaction products of (ii) and (iii)) with diketenes (i). The protective group redetaches from the amino group in the radical A of formula (XI) in the course of the reaction with diketene.

The radical A of formula (XI) can also be an α-amino radical of the formula —CH₂—NR²—H. In this case, the concomitant use of organic compounds (iii) is not preferred for the preparation.

Examples of radicals A are

### —CH₂—NH₂

### —CH(CH₃)—NH₂

### —C(CH₃)₂—NH₂

### —CH₂CH₂—NH₂

### —CH₂CH₂CH₂—NH₂

### —CH₂CH₂CH₂CH₂—NH₂

### —CH₂CH₂CH(CH₃)—NH₂

### —CH₂CH₂CH₂—NH—CH₂CH₂—NH₂

### —CH₂CH₂CH₂—N(CH₃)—CH₂CH₂—NH₂

### —CH₂CH₂CH₂[—NH—CH₂CH₂]₂—NH₂

### —CH₂CH₂C(CH₃)₂CH₂—NH₂,

of which —CH₂CH₂CH₂—NH₂ and —CH₂CH₂CH₂—NH—CH₂CH₂—NH₂ are preferred.

Examples of radicals B² when Y in the formulae (IV) and (V) is a nitrogen-containing radical are therefore

—CH₂CH₂CH₂—NH(-Z),

—CH₂CH₂CH₂—NH₁₋ₓ(-Z)ₓ-CH₂CH₂—NH(-Z),

where Z radicals are radicals of the formulae

—C(═O)—CHR³—C(═O)—CH₂R³ or

—C(═O)—CR³═C(—OH)—CH₂R³,

R³ is as defined above and preferably is a hydrogen atom, and
x is 0 or 1.

Siloxane polymers (1) which contain radicals B³ of the formulae (VI) and (VII) are obtained for example by transesterification of malonic esters with carbinol-functional siloxanes or amidation with aminosiloxanes, or by C-alkylation of malonic esters with haloalkylsiloxanes.

Examples of organic Si-free polyamines (2) which are used for preparing the compositions of the present invention are addition polymers of ethyleneimine, fully or partially hydrolyzed addition polymers of vinylformamide, homologs of ethylenediamine prepared from ammonia and dihaloethane, and reduced polynitriles,

of which addition polymers of ethyleneimine and fully hydrolyzed addition polymers of vinylformamide are preferred.

The polyamines (2) preferably contain 3 to about 10 000 amino groups, of which preferably 2 to 6000 are primary amino groups, preferably 20 to about 6000, more preferably 100 to 6000. Polyamines (2) can be linear, branched or cyclic in structure, in which case the primary amino functions can be disposed in terminal or pendent position. The polyamines (2) may contain secondary and/or tertiary amino groups as well as primary amino groups. Preference, however, is given to polyamines (2) in which the ratio of primary to secondary amino groups is preferably at least 2, more preferably at least 5 and even more preferably at least 20.

The polyamines (2) contain amine group concentrations in the range from preferably 10 to 26 meq/g, preferably 13 to 26 meq/g (meq/g=milliequivalent per gram of substance=equivalent per kilogram of substance).

Polyamines (2) are used in amounts of preferably 0.1 to 50 mol, preferably 0.5 to 20 mol, of primary amine group per mole of radical B in the siloxane polymers (1) and, where appropriate, compounds (3).

The preferably Si-free compounds (3) optionally included in the reaction contain at least one primary amino group or at least one radical B, preferably at least one radical B. Since these materials essentially have the function of a reactive additive and are less intended to contribute to the construction of copolymeric structures, their functionality tends to be on the low side: preferably the compounds (3) contain 1 to 3 radicals B, more preferably more exactly one radical B.

Preference is given to compounds (3) of polar (hydrophilic) structure, for example polyether acetoacetates (ethylene oxide and/or propylene oxide polymers, poly-THF), polyester acetoacetates or polyether polyester acetoacetates. Particular preference is given to using polyether monoacetoacetates which contain a radical B² of formula (IV) or (V) where Y=oxygen, as obtained for example as excess component in the preparation of silicone polyethers with subsequent reaction with diketene, and then are already present in the siloxane polymer (1).

The mixture of the present invention is prepared by mixing (1) with (2) and, where appropriate, (3).

The mixture is allowed to react at a temperature which is preferably in the range from 10 to 100° C. and more preferably in the range from 20 to 70° C. Preparing the mixture and allowing it to react preferably take place at the pressure of the ambient atmosphere, i.e., at about 1020 hPa, but can also take place at higher or lower pressures.

Mixing and reacting is effected by stirring using customary techniques, as with mixers providing low or high shearing, rotor-stator stirring devices and also stirred apparatus equipped with anchor stirrers or blade stirrers.

The reaction product obtained is useful for coating, impregnating, drenching or, in general, for treating uninterrupted or porous substrates.

The composition of the present invention and the reaction products obtained therefrom can be used for treating textiles or textile fabrics.

The composition of the present invention and the reaction products obtained therefrom have the advantage that the textiles or textile fabrics treated therewith are less prone to yellowing than textiles or textile fabrics treated according to the prior art.

The compositions of the present invention, containing the components (1), (2) and optionally (3), and the reaction products of the present invention which are obtained therefrom have the advantage that their mixtures with water are stabler than the mixtures with water of the components (1) and optionally (3) used.

Organic solvents can be used to prepare the compositions and/or reaction products. Examples of organic solvents are diethylene glycol monobutyl ether, propylene glycol, propylene glycol monomethyl ether or dipropylene glycol monomethyl ether.

Organic solvents can be used in amounts of 1 to 100 parts by weight, based on 100 parts by weight of the compositions of the present invention.

Water can be used in the preparation of the compositions or reaction products of the present invention. In such a case, it is preferable to obtain aqueous solutions, aqueous emulsions, aqueous dispersions or aqueous microemulsions.

Water can be used in amounts of 0.1 to 10 000 parts by weight, based on 100 parts by weight of the compositions or reaction products of the present invention.

In the aqueous solutions or emulsions, the amine groups in the compositions or reaction products can be protonated by addition of acids, such as acetic acids.

The process of the present invention can be carried out batchwise, semicontinuously or fully continuously.

### EXAMPLE 1

a) In a 2-liter three-neck flask, 440 g of allyl polyethylene oxide having an allyl content of 1.93 meq/g, 0.47 g of cyclohexene oxide and 1123 g of α,ω-dihydrodimethylpolysiloxane having 0.054% of Si-attached hydrogen are intensively stirred under nitrogen. The cloudy mixture is heated to 87° C. and the hydrosilylation reaction is started by addition of 1.63 g of a 1% solution of hexachloroplatinic acid in isopropanol. An exothermic reaction ensues and the contents of the flask clarify within about 5 minutes. After a further hour at 100° C., the batch contains less than 3 ppm of Si—H groups, which corresponds to a conversion of above 99%.

The batch is allowed to cool down to 50° C., 5 drops of triethylamine are added, and altogether 71.3 g of diketene are metered into the still warm batch in the course of half an hour. The internal temperature slowly rises to 74° C. After a further 2 hours at 70° C. diketene is no longer detectable. The slightly brownish product mixture has a concentration of 0.518 meq/g of aceto-acetate.

b) 200 g of this silicone polyether acetoacetate are heated to 55° C. together with 21.9 g of undiluted linear polyethyleneimine having an amine concentration of 24.7 meq/g. The viscosity rises and the initially cloudy mixture becomes homogeneously clear after a few minutes. The reaction mixture is allowed to react to completion at 70° C. in the course of half an hour and the now highly viscous product is diluted with 55.5 g of diethylene glycol monobutyl ether to obtain a clear 80% polymer solution having a viscosity of 4870 mm²/s (25° C.)

The polymer solution has a total basicity of 1.93 meq/g.

80 g of the solution are protonated with 7.6 g of acetic acid (99.5% strength) and stirred into 120 g of water. The mixture is gently sheared with a spatula to obtain a fine slightly yellowish aqueous emulsion.

As counter-sample, 80 g of an 80% solution (in diethylene glycol monobutyl ether) of the siloxane polymer with acetoacetate groups which was prepared in Example 1 under a) are stirred into 120 g of water to obtain a very cloudy mixture which separates into two phases. The same test with prior acidification of the 80% solution leads to the same result.

While the reaction product of β-ketocarbonyl-functional siloxane polymer and polyamine as per Example 1 b) is water soluble, the β-ketocarbonyl-functional siloxane polymer used is water insoluble.

### EXAMPLE 2

a) Example 1 is repeated to prepare 3.2 kg of a silicone polyether from 1206 g of the same α,ω-dihydrodimethylpolysiloxane and 2000 g of an allyl polyether of the formula CH₂═CH—CH₂O(C₂H₄O)₂₀(C₃H₆O)_{10.4}H having an allyl content of 0.65 meq/g. After addition of 10 drops of triethylamine, altogether 110 g of diketene are metered into the batch in the course of an hour in the temperature range 60-70° C. The batch is allowed to react at the same temperature for a further 2 hours until diketene is no longer detectable in the IR spectrum. The product mixture has an acetoacetate concentration of 0.393 meq/g and a viscosity of 4180 mm²/s at 25° C.

b) 200 g of this silicone polyether acetoacetate are diluted with 314 g of water and homogenized. 9.3 g of pentaethylenehexamine having an amine concentration of 25.8 meq/g are metered and thoroughly stirred into the homogenized mixture at 25° C., whereupon a slightly exothermic reaction ensues. After warming to 40° C., the viscosity increases distinctly until, after a further hour, a slightly yellowish emulsion having a total basicity of 0.46 meq/g is obtained. The polyaminosilicone polyether emulsion partially protonated with 1.1% by weight of acetic acid is dilutable with completely ion-free water in any proportion.

### EXAMPLE 3

54 g of the silicone polyether acetate having an acetate concentration of 0.393 meq/g, as prepared in Example 2 under a), are dissolved in 126 g of water and heated to 40° C. 20 g of a 30% aqueous solution of polyethyleneimine having an average molar mass of about 800 daltons and an amine concentration of 23.4 meq/g (Lupasol® FG, BASF) are metered into the batch. A slightly exothermic reaction and a viscosity increase take place to obtain a slightly cloudy, brownish polyaminosilicone polyether solution having a total basicity of about 0.70 meq/g, which is dilutable with completely ion-free water in any proportion.

### EXAMPLE 4

In a further combination of acetoacetate-functional siloxane polymer with a polyamine compound, 54 g of the silicone polyether acetoacetate prepared in Example 2 under a) are diluted with 216 g of water and heated to 40° C. 20 g of an aqueous polyvinylamine solution having an amine concentration of 19 meq/g (Lupamin 1595, 30%, BASF), diluted with half the amount of water, are speedily stirred into this solution. The temperature rises slightly and the viscosity rises appreciably to obtain a stable macroemulsion having a total basicity of about 0.38 meq/g, which is dilutable with completely ion-free water in any proportion.

The tendency to yellow is measured using Minolta Chromameter. To this end, cotton knit is pad-mangled to a finish liquor wet pick-up of about 85%. The liquor is prepared by diluting the 20% emulsion with 25 times the amount of completely ion-free water. The fabric is dried at 150° C. in 3 minutes and then at 180° C. for 2 minutes. The results are summarized in the table.

Comparative Test 1 as per U.S. Pat. No. 6,121,404:

Example 1 of U.S. Pat. No. 6,121,404 is repeated to prepare a water-soluble linear silicone polyether by hydro-silylation of 1450 g of an allyl ethoxylate having an average molecular weight of Mₙ=518 daltons with 950 g of an α,ω-dihydrodimethylpolysiloxane having an active hydrogen content of 0.21% in the presence of 0.72 g of cyclohexene oxide. The subsequent reaction with 230 g of diketene at 70° C. by catalysis with 0.3 g of triethylamine provides a clear silicone polyether acetoacetate having a β-keto ester content of 1.05 meq/g. A 10% solution of this copolymer in water accordingly has a β-keto ester content of 0.105 meq/g. 100 g of this 10% silicone polyether acetoacetate solution are mixed with the same amount of a conventional aminosilicone oil emulsion having a primary amino group content of 0.105 meq/g. The aminosilicone used was an addition copolymer composed of aminoethylaminopropylmethylsiloxy and dimethylsiloxy units, which is terminated with hydroxyl and methoxy groups and has a viscosity of 1560 mm²/s (25° C.). This mixture contains a total basicity of 0.105 meq/g and an active content (silicone polyether acetoacetate+amine oil) of about 20%.

The tendency to yellow was measured as described in Example 4 on a Minolta Chromameter. To this end, cotton knit is pad-mangled to a finish liquor wet pick-up of about 85%. The liquor is prepared by diluting the 20% mixture with 25 times the amount of completely ion-free water. The fabric is dried at 150° C. in 3 minutes and then at 180° C. for 2 minutes. The results are summarized in the table.

### Comparative Test 2:

Example 4 is repeated except that 600 g of the conventional aminosilicone oil emulsion from comparative test 1 are used in place of the aqueous polyvinylamine solution. The mixture is adjusted to 20% active content with a further 300 g of water and the mixture then contains a total basicity of 0.108 meq/g.

The tendency to yellow was measured as described in Example 4 on a Minolta Chromameter. To this end, cotton knit is pad-mangled to a finish liquor wet pick-up of about 85%. The liquor is prepared by diluting the 20% emulsion with 25 times the amount of completely ion-free water. The fabric is dried at 150° C. in 3 minutes and then at 180° C. for 2 minutes. The results are summarized in the table.

TABLE
Yellowness values on the L a b scale
(average of 3 measurements):

| | |
|---|---|
| Example 4: | b = +1.35 |
| Comparative test 1: | b = +2.75 |
| Comparative test 2: | b = +2.82 |
| Blank value: | b = +1.27 |

The greater the value of b, the greater the degree of yellowing. Comparative tests 1 and 2 clearly show the far greater yellowing of cotton which was finished on the basis of a conventional aminosilicone oil compared with a cotton fabric finished with an inventive mixture according to Example 4. This is all the more surprising in that the inventive liquor contains more than 3 times as much basic nitrogen—and that exclusively as primary amine—which is conventionally considered to be the main cause of the yellowing of amine softeners on cotton.

1.-12. (canceled)

13. A compositions comprising
(1) at least one P-ketocarbonyl-functional siloxane polymer containing at least one trivalent radical B of the formula 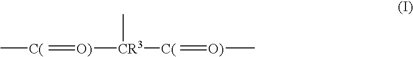
where
R³ represents a hydrogen atom or a monovalent hydrocarbyl radical having 1 to 30 carbon atoms,
(2) at least one organic Si-free polyamine containing at least three amino groups of which at least two are primary amino groups,
and optionally
(3) one or more silicon-free compounds containing at least one radical B of formula (I) or at least one primary amino group,
with the proviso that the composition provides soluble reaction products after components (1), (2) and (3) when present, have been allowed to react.

14. The composition of claim 13 wherein R³ is H.

15. The composition of claim 13, wherein radical B in the siloxane polymer (1) comprises SiC-attached radicals B¹ of the formulae 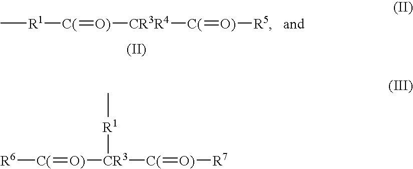
where
R¹ represents a bivalent organic radical which has 1 to 200 carbon atoms and which, except in the terminal positions, optionally contains one or more heteroatoms selected from the group consisting of oxygen, sulfur and nitrogen,
R⁴ is a hydrogen atom or a hydrocarbyl radical having 1 to 30 carbon atoms,
R⁵, R⁶ and R⁷ each represent a hydrocarbyl radical having 1 to 30 carbon atoms.

16. The composition of claim 15, wherein R¹ is a C₁₋₂₀ hydrocarbyl radical.

17. The composition of claim 15, wherein R⁴ is hydrogen.

18. The composition of claim 13, wherein at least one radical B in the siloxane polymers (1) comprises an SiC-attached radical B² of the formulae
—R⁸—Y—C(═O)—CHR³—C(═O)—CH₂R³ (IV) and
—R⁸—Y—C(═O)—CR³═C(—OH)—CH₂R³ (V)
where
Y represents an oxygen atom or a radical of the formula —(NR⁹—R′)_{z}—NR²—, where R′ represents a bivalent hydrocarbyl radical having 1 to 6 carbon atoms,
R² represents a hydrogen atom or a hydrocarbyl radical having 1 to 18 carbon atoms,
R⁸ represents a bivalent organic radical which has 1 to 200 carbon atoms and which may contain heteroatoms selected from the group consisting of oxygen, sulfur and nitrogen,
R⁹ represents R² or a radical of the formula —C(═O)—CHR³—C(═O)—CH²R³ or —C(═O)CR³═C(—OH)—CH₂R³,
z is 0 or a whole number from 1 to 10.

19. The composition of claim 18, wherein Y is an oxygen atom, R² is hydrogen, and R⁸ is a bivalent hydrocarbyl radical having up to 120 carbon atoms, optionally containing one or more non-adjacent oxygen atoms.

20. The composition of claim 17, wherein in formula (IV) and (V)
Y is an oxygen atom and
R⁸ is a polyether radical of the formula
—R¹⁰—(OC₂H₄)_{c}—(OC₃H₆)_{f}—(OC₄H₈)ₕ—CᵢH₂ᵢ—(Y) (X)
where R¹⁰ represents an alkylene radical having 2 to 20 carbon atoms,
—(Y) is the bond to Y in the formulae (IV) and (V), where Y is an oxygen atom, e, f, and h each represent 0 or a whole number from 1 to 100 with the proviso that the sum total e+f+h is ≧1, and i is 2, 3 or 4.

21. The composition of claim 13, wherein radical B³ in the siloxane polymers (1) comprise SiC-attached radicals B³ of the formulae 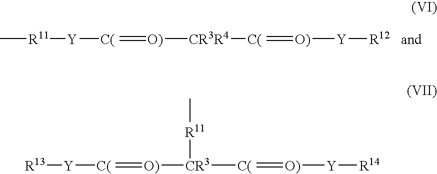
R¹¹ represents a bivalent organic radical,
R⁴ is a hydrogen atom or a hydrocarbyl radical having 1 to 30 carbon atoms,
R⁵, R⁶ and R⁷ each represent a hydrocarbyl radical having 1 to 30 carbon atoms.

22. The composition of claim 13, wherein siloxane polymers (1) comprise organopolysiloxanes of the formula
X_{g}R_{3-g}SiO(SiR₂O)ₗ(SiRXO)ₖSiR_{3-g}X_{g} (IXa) and
(R¹⁵O)R₂SiO(SiR₂O)ₙ(SiRXO)ₘSiR₂(OR¹⁵) (IXb)
where
X represents an organic radical which contains the radical B, which optionally is an SiC-attached radical B¹, B² or B³,
wherein radicals B¹ are of the formulae 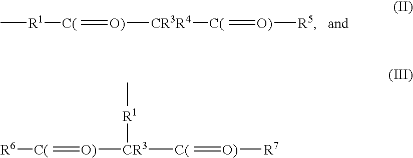
R¹ represents a bivalent organic radical which has 1 to 200 carbon atoms and which, except in the terminal positions, optionally contains one or more heteroatoms selected from the group consisting of oxygen, sulfur and nitrogen,
R⁴ is a hydrogen atom or a hydrocarbyl radical having 1 to 30 carbon atoms,
R⁵, R⁶ and R⁷ each represent a hydrocarbyl radical having 1 to 30 carbon atoms,
Y represents an oxygen atom or a radical of the formula —(NR⁹—R′)_{z}—NR²—, wherein radicals B² are of the formulae
—R⁸—Y—C(═O)—CHR³—C(═O)—CH₂R³ (IV) and
—R⁸Y—C(═O)—CR³═C(—OH)—CH₂R³ (V)
where R′ represents a bivalent hydrocarbyl radical having 1 to 6 carbon atoms,
R² represents a hydrogen atom or a hydrocarbyl radical having 1 to 18 carbon atoms,
R⁸ represents a bivalent organic radical which has 1 to 200 carbon atoms and which may contain heteroatoms selected from the group consisting of oxygen, sulfur and nitrogen,
R⁹ represents R² or a radical of the formula —C(═O)—CHR³—C(═O)—CH²R³ or —C(═O)—CR³═C(—OH)—CH₂R³,
z is 0 or a whole number from 1 to 10,
wherein radicals B³ are of the formulae 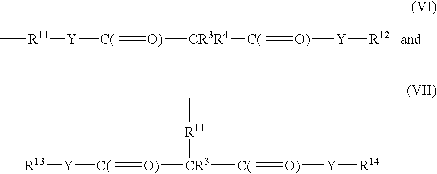
R¹¹ represents a bivalent organic radical,
R⁴ is a hydrogen atom or a hydrocarbyl radical having 1 to 30 carbon atoms,
R⁵, R⁶ and R⁷ each represent a hydrocarbyl radical having 1 to 30 carbon atoms,
R represents a monovalent, optionally substituted hydrocarbyl radical having 1 to 18 carbon atoms per radical,
R¹⁵ represents a hydrogen atom or an alkyl radical having 1 to 8 carbon atoms,
g is 0 or 1,
k is 0 or a whole number from 1 to 30,
l is 0 or a whole number from 1 to 1000,
m is a whole number from 1 to 30, and
n is 0 or a whole number from 1 to 1000,
with the proviso that on average at least one radical X is present per molecule.

23. The composition of claim 22, wherein the radicals X are SiC-attached radicals B².

24. The composition of claim 13, wherein mixtures of the compositions containing components (1), (2) and optionally (3) with water are more stable than mixtures of the components (1) and optionally (3) with water.

25. The composition of claim 13, wherein said organic Si-free polyamines (2) comprise organic Si-free polyamines containing an amine group concentration in the range from 10 to 26 meq/g (meq/g=milliequivalent per gram of substance).

26. A process for preparing a composition of claim 13, comprising preparing a mixture containing
(1) at least one P-ketocarbonyl-functional siloxane polymer containing at least one trivalent radical B of the formula 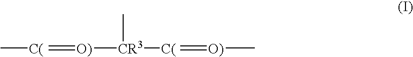
where
R³ represents a hydrogen atom or a monovalent hydrocarbyl radical having 1 to 30 carbon atoms,
(2) at least one organic Si-free polyamine containing at least three amino groups of which at least two are primary amino groups,
and optionally
(3) one or more silicon-free compounds containing at least one radical B of formula (I) or at least one primary amino group,
with the proviso that after components (1), (2) and optionally (3) have been allowed to react, the reaction products are soluble.

27. A reaction product obtained by reacting a composition of claim 13.

28. The reaction products of claim 11, wherein the reaction products obtained from the components (1), (2) and optionally (3) in admixture with water are more stable than the components (1) and optionally (3) in admixture with water.

29. The composition of claim 13, further comprising a textile or textile fibers, a reaction product of components (1), (2), and (3) when used, deposited onto the textile or textile fiber.

30. The composition of claim 29, prepared by contacting a textile or textile fibers with a textile treating composition comprising an aqueous dilution of the reaction product.
